(19) United States
(12) Patent Application Publication
(10) Pub. No.: US 2008/0026957 A1
(43) Pub. Date: Jan. 31, 2008

(54) Treatment and Production of Subterranean Formations with Heteropolysaccharides

(76) Inventors: M. Nihat Gurmen, Corpus Christi, TX (US); Paul R. Howard, Sugar Land, TX (US); Carlos Abad, Richmond, TX (US); Alex Ahrenst, Kokstad (NO); Temara Peet, Brigh (AU); Alejandro Pena, Urbanizacion Tamare (VE); Alexander D. Shapovalov, Nefteyugansk (RU)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/835,891

(22) Filed: Aug. 8, 2007

Related U.S. Application Data
(63) Continuation-in-part of application No. 11/384,686, filed on Mar. 20, 2006.
Application No. 11/384,686 is a continuation-in-part of application No. 11/339,015, filed on Jan. 25, 2006.
Application No. 11/339,015 is a continuation-in-part of application No. 11/042,215, filed on Jan. 24, 2005.

(51) Int. Cl. C09K 8/00

(52) U.S. Cl. 507/211

(57) ABSTRACT

Disclosed are methods of treating wells and producing fluids from subterranean formations with treatment fluids comprising heteropolysaccharides. In particular, the invention relates to treatment and production methods with fluids containing a heteropolysaccharide, aqueous medium, and an electrolyte, wherein the fluids may further include a gas component, a surfactant and/or an organoamino compound. The fluids render significant drag reduction, good Theological properties and unusually rapid hydration rates.

### CROSS REFERENCE TO RELATED APPLICATIONS

This application claims is a continuation-in-part of and also claims the benefit of U.S. Non-provisional application Ser. No. 11/384,686, filed Mar. 20, 2006, which is a continuation-in-part of Ser. No. 11/339,015, filed Jan. 25, 2006, which is a continuation-in-part of Ser. No. 11/042,215, filed Jan. 24, 2005, each of which is hereby incorporated herein by reference.

### BACKGROUND OF THE INVENTION

This invention relates to methods of treating a well adjacent to a subterranean formation and producing fluids from the subterranean formation. In particular, the invention relates to treatment methods using fluids containing heteropolysaccharides.

Various types of fluids are used in operations related to the development and completion of wells that penetrate subterranean formations, and to the production of gaseous and liquid hydrocarbons from natural reservoirs into such wells. These operations include perforating subterranean formations, fracturing subterranean formations, modifying the permeability of subterranean formations, or controlling the production of sand or water from subterranean formations. The fluids employed in these oilfield operations are known as drilling fluids, completion fluids, work-over fluids, packer fluids, fracturing fluids, stimulation fluids, conformance or permeability control fluids, consolidation fluids, and the like. Most common fluid types include straight fluids, foamed fluids, and energized fluids. The aforementioned commonly assigned U.S. application Ser. No. 11/042,215, filed Jan. 24, 2005 (US 2006-0166836 A1), discloses diutan and other sphingans for preparing energized fluids.

Aqueous solutions are commonly used as treating fluids. Water is known to cause high pumping pressures due to significant frictional pressure losses, particularly at high pumping rates and turbulent flow regime. For this reason, friction reducing agents are often added to these fluids.

For example, low-cost fracturing fluids commonly referred to as slick-water comprise low concentrations of friction reducers along with inorganic salts or organic substitutes to prevent swelling of indigenous clays. Unfortunately, conventional slick-water fluid systems do not have good proppant carrying capacities. Therefore, operators traditionally rely on turbulence at high pump rates to carry low proppant concentrations into the formation to create a propped hydraulic fracture. The required horsepower often constrains these treatments from cost and operational standpoints. The need exists for additives that, when used at very low concentrations, render significant friction reduction whilst improving the proppant carrying capacity of the treating fluid.

The industry standard for friction reduction in oilfield applications is polyacrylamide polymers, co-polymers, or mixtures thereof. U.S. Pat. No. 3,442,803 to Hoover et al discloses reducing friction in an aqueous oil well fracturing system by dissolving in the aqueous system a small amount of a copolymer of acrylamide and methylene bisacrylamide. These products can be prepared with cationic, anionic or non-ionic end groups depending on the application.

The present invention relates to improved friction reducing agents in the various methods in which they are employed.

### SUMMARY OF THE INVENTION

The invention discloses methods of treating a well using fluid containing a heteropolysaccharide friction reducing agent. Fluids used in the method can be rapidly hydratable and in an embodiment have adequate rheology for good proppant suspension and transport.

The present invention provides in one embodiment a method of treating a well. The method can include pumping at least one stage of an aqueous fluid system into the well at a rate to incur friction pressure losses. The fluid system can include a heteropolysaccharide friction reducing agent in an amount up to 1.5 percent, preferably up to 1 percent, and more preferably from 0.01 to 0.4 percent by weight of the total liquid phase, to provide a drag reduction of at least 50%, preferably at least 60%.

The aqueous fluid system can include brine. In embodiments, the brine can have a density of at least 998 Kg/m³, at least 1060 Kg/m³ or at least 1300 Kg/m³.

In an embodiment, the aqueous fluid system can include proppant. In embodiments, the method can comprise slick-water fracturing of a subterranean formation, high rate water packing of the well, clean out of the well, or the like. In an embodiment, the pumping rate can be enough to generate linear fluid velocities of at least 4 m/s calculated as the ratio of the volumetric flow rate to the cross-sectional area. In another embodiment, the aqueous fluid system can further include fibers to assist transport of the proppant.

In an embodiment, the heteropolysaccharide comprises a tetrasaccharide repeating unit in the polymer backbone represented by the chemical formula: 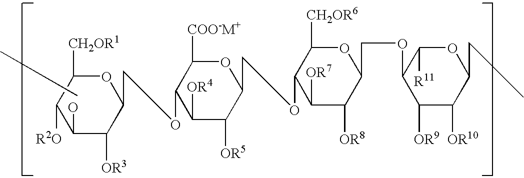
wherein three different saccharides are present in the repeating unit including D-glucose, D-glucuronic acid, and either L-rhamnose or L-mannose; M⁺ is an ionic species; R¹, R², R³, R⁴, R⁵, R⁶, R⁷, R⁸, R⁹, and R¹⁰ are selected from the group consisting of hydrogen, methyl, acetyl, glyceryl or a saccharide group containing one to three saccharide units; R¹¹ is a methyl or methylol group; a weight average molecular weight (Mw) for the heteropolysaccharide is from about 10⁵ to about 10⁷.

In another embodiment, the heteropolysaccharide can be selected from the group consisting of gellan gum and derivatives thereof, diutan gum and derivatives thereof, rhamsan gum and derivatives thereof, polysaccharide S-88 and derivatives thereof, polysaccharide S-198 and derivatives thereof, polysaccharide NW11 and derivatives thereof, and mixtures thereof.

In a further embodiment, the heteropolysaccharide comprises a hexasaccharide repeating unit in the polymer backbone represented by the chemical formula: 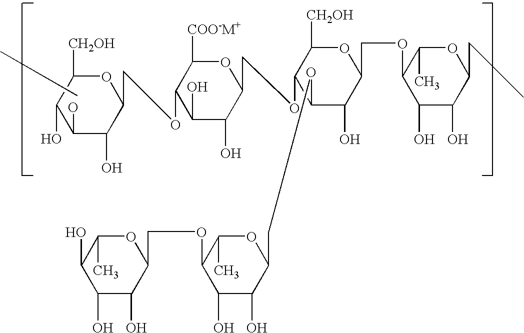
wherein M⁺ is an ionic species and a weight average molecular weight for the heteropolysaccharide is from about 10⁵ to about 10⁷.

In an embodiment, the at least one stage can be an initial proppant-lean pad stage to initiate and propagate a fracture in a subterranean formation adjacent to the well. The initial proppant-lean pad stage can be followed by a series of proppant-laden stages comprising an aqueous fluid system. The proppant-laden stages can include a friction reducing agent that can be the same or different than the heteropolysaccharide. The friction reducing agent in the proppant laden stages can be a polymeric drag reducer in one embodiment, or a viscoelastic surfactant drag reducer in another embodiment.

In another embodiment, the proppant-laden stages can be a linear or crosslinked polymer gel, or a viscoelastic surfactant gel.

In one embodiment, the method can include an initial proppant-lean pad stage to initiate and propagate a fracture in a subterranean formation adjacent the well, followed by a series of proppant-laden stages. The proppant-laden stages can include the fluid system with the heteropolysaccharide friction reducing agent, wherein the initial pad stage can include an aqueous fluid system comprising a friction reducing agent that can be the same or different than the heteropolysaccharide. The friction reducing agent in the initial pad stage can be a polymeric drag reducer, or a viscoelastic surfactant drag reducer.

In another embodiment, an initial proppant-lean pad stage can initiate and propagate a fracture in a subterranean formation adjacent to the well, followed by a series of proppant-laden stages. The proppant-laden stages can include a friction reducing agent that can be the same or different than the heteropolysaccharide. Alternatively or additionally, the friction reducing agent in the proppant laden stages can include a polymeric drag reducer, a viscoelastic surfactant drag reducer, or the like. In embodiments, the proppant laden stages can include a linear or crosslinked polymer gel, a viscoelastic surfactant gel, or the like.

In an embodiment, the method can include an initial proppant-lean pad stage to initiate and propagate a fracture in a subterranean formation adjacent the well, followed by a series of proppant-laden stages, wherein the initial pad stage can include an aqueous fluid system comprising a friction reducing agent that can be the same or different than the heteropolysaccharide, and the proppant-laden stages can include the fluid system with the heteropolysaccharide friction reducing agent. In an embodiment, the initial pad stage can include a polymeric drag reducer, a viscoelastic surfactant drag reducer, or the like.

In an embodiment, the method can include an initial proppant-lean pad stage to initiate and propagate a fracture in a subterranean formation adjacent the well followed by a series of proppant-laden stages, wherein the proppant-laden stages can include the fluid system with the heteropolysaccharide friction reducing agent, and the initial pad stage can include an aqueous fluid system comprising a gelling agent, which can be a linear or crosslinked polymer gel, or a viscoelastic surfactant gel.

In an embodiment, the aqueous fluid system can be energized with a gas phase. The gas phase can comprise methane, nitrogen, carbon dioxide, or the like.

In an embodiment, the aqueous fluid system can further comprise a fluid loss additive.

In an embodiment, the proppant can include a coating, or a blend of proppants exhibiting a range of different densities, to form a conductive channel in a fracture in a subterranean formation adjacent the well.

In another embodiment, the aqueous fluid system can also include fibers, and the at least one stage can divert treatment fluid from a formation zone of relatively high permeability to a formation zone of relatively low permeability.

In an embodiment, the at least one stage can include a conformance control stage.

In an embodiment, the at least one stage can include an enhanced oil recovery flood stage.

In an embodiment, the aqueous fluid system can include a viscoelastic surfactant.

In an embodiment, the heteropolysaccharide can be crosslinked.

In an embodiment, the aqueous fluid system can include a breaker for the heteropolysaccharide.

In an embodiment, the aqueous fluid system can have a viscosity at 25° C. and 100 s⁻¹ of at least 5 mPa-s, and/or a viscosity at 25° C. and 0.1 s⁻¹ of at least 200 mPa-s.

Another embodiment of the invention provides a method of treating a well and producing fluid from a subterranean formation adjacent to the well. The method can include pumping at least one stage of an aqueous fluid system into the well at a rate to incur friction pressure losses, wherein the fluid system comprises a heteropolysaccharide friction reducing agent in an amount up to 1.5 percent by weight of a liquid phase to provide a drag reduction of at least 50%, as described in the various embodiments above, and producing fluid from the subterranean formation.

### BRIEF DESCRIPTION OF THE DRAWINGS

FIG. 1 graphically compares drag reduction of diutan heteropolysaccharide at concentrations of 0.04 wt % and 0.12 wt % (3.3 and 10 lbm/1000 gal) in fresh water in a 7.92 mm ID (½ inch OD) pipe with a 0.10 vol % polyacrylamide-based drag reducing agent, further referred to as conventional friction reducer (CFR) (available from Schlumberger, 110 Schlumberger Dr Sugar Land, Tex. 77478) in fresh water. This figure illustrates that diutan heteropolysaccharide renders similar or better drag reduction properties than conventional drag reducing agents when used at similar concentrations.

FIG. 2 graphically compares the viscosity versus shear rate for a diutan heteropolysaccharide fluid according to the present invention with a similar fluid containing a conventional friction reducer (CFR) as described in Example 1 and shows that the diutan fluid can have improved rheological and therefore solid-suspending properties.

FIG. 3 graphically compares friction pressure losses for varying concentrations of diutan in 10 wt % KCl pumped through 44 mm (1.75″) OD coiled tubing and shows friction pressure losses can be substantially inhibited by the addition of diutan heteropolysaccharide, particularly at high flow rates.

FIG. 4 graphically compares friction pressure losses for varying concentrations of diutan in 10 wt % KCl pumped through 38 mm (1.50″) OD coiled tubing and shows friction pressure losses can be substantially inhibited by the addition of diutan heteropolysaccharide, particularly at high flow rates.

FIG. 5 graphically compares friction pressure losses for varying concentrations of diutan in 38.5 wt % NaBr pumped through 44 mm (1.75″) coiled tubing and shows friction pressure losses can be substantially inhibited by the addition of diutan heteropolysaccharide, particularly at high flow rates.

FIG. 6 graphically compares friction pressure losses for varying concentrations of diutan in 38.5 wt % NaBr pumped through 38 mm (1.50″) coiled tubing and shows friction pressure losses can be substantially inhibited by the addition of diutan heteropolysaccharide, particularly at high flow rates.

FIG. 7 graphically compares the viscosity versus shear rate for a diutan heteropolysaccharide fluid according to the present invention against a similar fluid containing a conventional friction reducer (CFR) as described in Example 3 and shows that the diutan fluid can have improved rheological and therefore solid-suspending properties.

FIG. 8 graphically compares the viscosity versus shear rate for two diutan heteropolysaccharide fluids at different concentrations according to the present invention against a similar fluid containing a conventional friction reducer (CFR) as described in Example 4, and shows that the diutan fluid can have improved rheological and therefore solid-suspending properties.

### DETAILED DESCRIPTION OF THE PREFERRED EMBODIMENTS

The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited. In the summary of the invention and this detailed description, each numerical value should be read once as modified by the term “about” (unless already expressly so modified), and then read again as not so modified unless otherwise indicated in context.

The invention discloses methods for treating a well, e.g. in communication with a subterranean formation. In particular, the invention uses aqueous wellbore treatment fluids containing a heteropolysaccharide friction reducing agent. In one embodiment, the fluids are not introduced into a hydration tank prior to injection into a wellbore for purposes of hydrating the fluid. As used herein, the term “liquid phase” is meant to include all components of the fluid except any gas phase. The term “gas” is used herein to describe any fluid in a gaseous state or in a supercritical state, wherein the gaseous state refers to any state for which the temperature of the fluid is below its critical temperature and the pressure of the fluid is below its vapor pressure, and the supercritical state refers to any state for which the temperature of the fluid is above its critical temperature. As used herein, the terms “energized fluid” and “fluid” are used interchangeably to describe any stable mixture of gas phase and liquid phase, including foams, notwithstanding the foam quality value, i.e. the ratio of gas volume to the total volume of gas and liquid phases.

It has been unexpectedly discovered that combining a heteropolysaccharide, such as a sphingan with an electrolyte, provides an aqueous well treatment fluid which offers both low friction pressure and substantial particle suspension and transport abilities. The fluid can rapidly hydrate, and, when used with a gas component and a surfactant, can exhibit improved gas phase stability, especially at elevated temperatures. As such, aqueous fluids used in methods of the invention can include an aqueous medium and a heteropolysaccharide, and in various embodiments, salt (brine), proppant, fibers, a gas component, or the like.

The aqueous medium is usually water or brine. In those embodiments of the invention where the aqueous medium is a brine, the brine is water comprising an inorganic salt or organic salt. Preferred inorganic salts include alkali metal and ammonium halides, more preferably sodium, potassium or ammonium chloride. The carrier brine phase may also comprise an organic salt more preferably sodium, potassium, or cesium formate. Preferred inorganic divalent salts include calcium halides, more preferably calcium chloride or calcium bromide. Sodium bromide, potassium bromide, cesium bromide, or zinc bromide may also be used. Mixtures of various brines can also be used. The brine is chosen according to the density requirements for the treatment, varying between 998 Kg/m³ and 2516 Kg/m³, for example, at least 998 Kg/m³, at least 1060 Kg/m³ or at least 1300 Kg/m³. The salt is chosen for compatibility reasons i.e. where the reservoir drilling fluid used a particular brine phase and the completion/clean up fluid brine phase is chosen to have the same brine phase.

The fluids used in the invention can include an electrolyte which may be an organic acid, organic acid salt, inorganic salt or a polyelectrolyte. Uses of mixtures of the above members are specifically contemplated as falling within the scope of the invention.

The organic acid is typically a sulfonic acid or a carboxylic acid, and the anionic counter-ion of the organic acid salts is typically a sulfonate or a carboxylate. Representative of such organic molecules include various aromatic sulfonates and carboxylates such as p-toluene sulfonate, naphthalene sulfonate, chlorobenzoic acid, salicylic acid, phthalic acid and the like, where such counter-ions are water-soluble. Most preferred organic acids are formic acid, citric acid, 5-hydroxy-1-napthoic acid, 6-hydroxy-1-napthoic acid, 7-hydroxy-1-napthoic acid, 1-hydroxy-2-naphthoic acid, 3-hydroxy-2-naphthoic acid, 5-hydroxy-2-naphthoic acid, 7-hydroxy-2-napthoic acid, 1,3-dihydroxy-2-naphthoic acid, and 3,4-dichlorobenzoic acid.

The inorganic salts that are particularly suitable include, but are not limited to, water-soluble potassium, sodium, and ammonium salts, such as potassium chloride and ammonium chloride. Additionally, magnesium chloride, calcium chloride, calcium bromide, sodium bromide, zinc halide, sodium carbonate, and sodium bicarbonate salts may also be used. Any mixtures of the inorganic salts may be used as well. The inorganic salts may aid in the development of increased viscosity that is characteristic of preferred fluids. Further, the inorganic salt may assist in maintaining the stability of a geologic formation to which the fluid is exposed. Formation stability and in particular clay stability (by inhibiting hydration of the clay) is achieved at a concentration level of a few percent by weight and as such the density of fluid is not significantly altered by the presence of the inorganic salt unless fluid density becomes an important consideration, at which point, heavier inorganic salts may be used. In a preferred embodiment of the invention, the electrolyte is potassium chloride. The electrolyte is preferably used in an amount of from about 0.01 wt % to about 40.0 wt % of the total liquid phase weight, and more preferably from about 1.0 wt % to about 8.0 wt % of the total liquid phase weight.

Fluids used in methods of the invention include a heteropolysaccharide. While any suitable heteropolysaccharide may be used, microbial polysaccharides commonly known as sphingans are particularly useful. Sphingans generally are acidic capsular heteropolysaccharides secreted by Sphingomonas bacteria as described by Pollock, T. J., Sphingan Group of Heteropolysaccharides (EPS), in Biopolymers, Vol. 5, E. J. Vandamme, S. DeBaets, and A. Steinbüchel, Editors. 2002, Wiley-VCH Verlag GmbH, p. 239-258. In some embodiments of the invention, the heteropolysaccharide is an sphingan or a derivatized sphingan having a tetrasaccharide repeating unit in the polymer backbone as represented by the chemical formula: 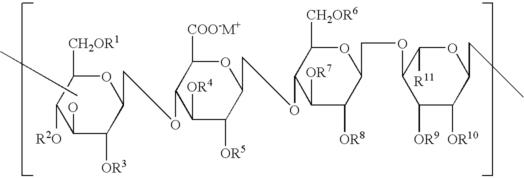
or represented by the alternative formula scheme: 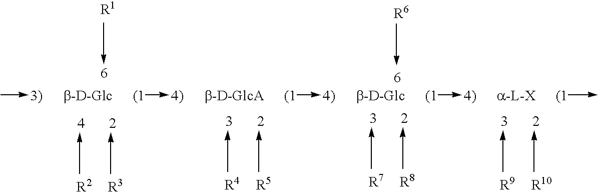
wherein at least three different saccharides are present in the repeating unit, such saccharides including D-glucose (D-Glc), D-glucuronic acid (D-GlcA), and either L-rhamnose (X=Rha; R¹¹═CH₃) or L-mannose (X=Man; R¹¹═CH₂OH); the weight average molecular weight (Mw) for the heteropolysaccharide is from about 10⁵ to about 10⁷; M⁺ is any ionic species effective to associate via electrostatic interactions with the carboxylic group present in the D-glucuronic acid unit, wherein M⁺ includes, for example, but not necessarily limited to: H⁺, Na⁺, K⁺, NH₄⁺, ½ Ca⁺² and ½ Mg⁻²; substituents for the number 2 positions of all saccharide units (R³, R⁵, R⁸, and R¹⁰), substituents for the number 3 positions of the position number 4-linked saccharide units (R⁴, R⁷, and R⁹), substituent for the number 4 position of the position 3-linked glucose unit (R²), and substituents for the number 6 positions of the D-glucose units (R¹ and R⁶) may be by non-limiting example a hydrogen (—H), methyl (—CH₃), acetyl (—COCH₃), glyceryl (—COCH₂(OH)CH₂OH) or a saccharide group containing one to three saccharides units, wherein the saccharide units present in the saccharide side-group include, but are not limited to: D-glucose, D-glucuronic acid, D-galacturonic acid, L-rhamnose, L-mannose, D-mannose, 2,3:5,6-gi-O-isopropylidene-D-mannofuranose, 2,3-O-isopropylidene-D-ribono-1,4-lactone, 3,4-O-isopropylidene-D-mannitol, D-arabinose, L-arabinose, D-erythrose, L-erythrose, D-fucose, L-fucose, lactulose, D-lyxose, maltulose, L-mannitol, D-mannono-1,4-lactone, L-mannono-1,4-lactone, methyl-α-D-fucopyranoside, D-ribonic acid, D-ribono-1,4-lactone, L-ribose, D-sorbose, D-tagatose, D-talitol, D-talose, L-xylose, and the like, and any derivatives. Also, the substituents R¹ thru R¹¹ above may differ from repeating unit to repeating unit within the heteropolysaccharide's backbone chemical structure. For example, R¹ could be hydrogen (—H) in one repeating unit and an acetyl group (—COCH₃) in the following repeating unit.

Suitable sphingans or derivatized sphingans include, but are not necessarily limited to the following heteropolysaccharides and derivatives thereof:

Gellan gum as described in Kuo, M. S., A. J. Mort, and A. Dell, Identification and location of L-glycerate, an unusual acyl substituent in gellan gum, Carbohydrate Research, 1986, 156: p. 173-187, wherein R¹, R², R³, R⁴, R⁵, R⁶, R⁷, R⁸, R⁹, and R¹⁰ are hydrogen (—H) groups, and R¹¹ is a methyl (—CH₃) group (or X=Rha);

Welan gum as described by Stankowski, J. D. and S. G. Zeller, Location of the O-acetyl group in welan by the reductive-cleavage method, Carbohydrate Research, 1992, 224: p. 337-341, wherein R¹, R², R³, R⁴, R⁵, R⁶, R⁸, R⁹, and R¹⁰ are hydrogen (—H) groups, R¹¹ is a methyl (—CH₃) group (or X=Rha), and R⁷ is an α-L-rhamnose or α-L-mannose group (α-L-Rha (1→, or α-L-Man (1→);

Diutan gum as described by Chowdhury, T. A., et al., Structural studies of an extracellular polysaccharide, S-657, elaborated by Xanthomonas ATCC 53159, Carbohydrate Research, 1987, 164: p. 117-122, wherein R¹, R², R³, R⁴, R⁵, R⁶, R⁸, R⁹, and R¹⁰ are hydrogen (—H) groups, R¹¹ is a methyl (—CH₃) group (or X=Rha), and R⁷ is two α-L-rhamnose groups linked at the 1,4 ring positions (α-L-Rha (1→4) α-L-Rha (1→). Diutan gum may also be referred as polysaccharide S-8 in the literature;

Heteropolysaccharide S-8 available from CP Kelco of 123 North Wacker Dr, Suite 2000 Chicago, Ill. 60606 USA, described by the manufacturer as a more pure strand of duitan gum with respect to the S-657 strand. Purity is defined by the manufacturer for this product as % Diutan=% CO₂*(Mass of diutan repeating unit)/(mass of CO₂). The repeat unit mass was 992.93, assuming no acetate and the K⁺ form. Hence, for S-8 strain, 4.0% CO₂ content was reported and purity=4*992.93/44=90.3%, as compared with S-657, 3.2% CO₂ giving purity=3.2*992.93/44=72.2%.

Rhamsan gum as described by Jansson, P. E., et al., Structural studies of a polysaccharide (S-194) elaborated by Alcaligenes ATCC 31961, Carbohydrate Research, 1986, 156: p. 157-163, wherein R², R³, R⁴, R⁵, R⁶, R⁷, R⁸, R⁹, and R¹⁰ are hydrogen (—H) groups, R¹¹ is a methyl (—CH₃) group (or X=Rha), and R¹ is two β-D-glucose groups linked at the 1,6 ring positions (β-D-Glc (1→6) β-D-Glc (1→);

Heteropolysaccharide S-88 as described by Jannson, P. E., N. S. Kumar, and B. Lindberg, Structural studies of a polysaccharide (S-88) elaborated by Pseudomonas ATCC 31554, Carbohydrate Research, 1986, 156: p. 165-172, wherein R¹, R², R³, R⁴, R⁵, R⁶, R⁸, R⁹, and R¹⁰ are hydrogen (—H) groups, R¹¹ is a methyl (—CH₃) group (X=Rha) or methylol (—CH₂OH) group (X=Man), and R⁷ is an α-L-rhamnose group (α-L-Rha (1→);

Heteropolysaccharide S-198 as described by Chowdhury, T. A., B. Lindberg, and U. Lindquist, Structural studies of an extracellular polysaccharide (S-198) elaborated by Alcaligenes ATCC 31853, Carbohydrate Research, 1987, 161: p. 127-132, wherein R¹, R³, R⁴, R⁵, R⁶, R⁷, R⁸, R⁹, and R¹⁰ are hydrogen (—H) groups, R¹¹ is a methyl (—CH₃) group (X=Rha) or methylol (—CH₂OH) group (X=Man), and R² is an α-L-rhamnose group (α-L-Rha (1→); and,

Heteropolysaccharide NW11 as described in Pollock, T. J., Sphingan Group of Heteropolysaccharides (EPS), in Biopolymers, Vol. 5, E. J. Vandamme, S. DeBaets, and A. Steinbüchel, Editors, 2002, Wiley-VCH Verlag GmbH, p. 239-258, wherein R¹, R², R³, R⁴, R⁵, R⁶, R⁷, R⁸, R⁹, and R¹⁰ are hydrogen (—H) groups, and R¹¹ is a methylol (—CH₂OH) group (X=Man).

Preferably, the heteropolysaccharide used in fluids of the invention is a diutan gum having a hexasaccharide repeating unit in the polymer backbone as represented by the chemical formula: 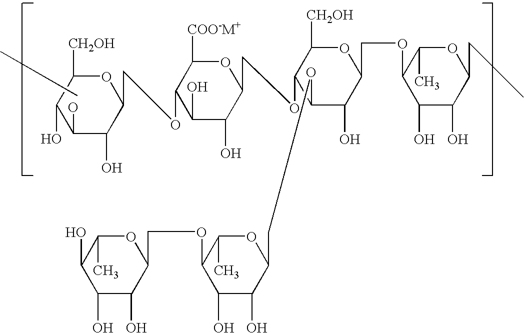
or represented by the alternative formula scheme: 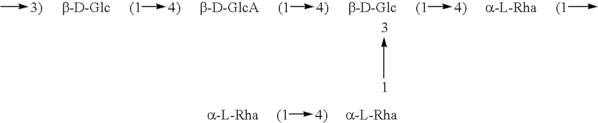
wherein M⁺ is any ionic species effective to associate via electrostatic interactions with the carboxylic group, wherein M⁻ includes, for example, but not necessarily limited to, H⁺, Na⁺, K⁺, NH₄⁺, ½ Ca⁺² and ½ Mg⁺²; and the weight average molecular weight (Mw) for the diutan gum is from about 10⁵ to about 10⁷. Diutan heteropolysaccharides are available, for example, from CP Kelco of 123 North Wacker Dr, Suite 2000 Chicago, Ill. 60606 USA, and may also be used in either crosslinked form, or without crosslinker. Diutan is generally composed of carbohydrate, about 12% protein and about 7% (calculated as O-acetyl) acyl groups, where the carbohydrate portion containing about 19% glucuronic acid, and the neutral sugars rhamnose and glucose are present in the approximate ratio of 2:1. Details of preparing diutan are given in U.S. Pat. No. 5,175,278 (Peik et al.), hereby incorporated by reference. O-acetyl groups may also be present on the number 2 position and the 2,6-positions of the 3-linked D-Glucose unit as described in Diltz, S. and S. G. Zeller, Location of O-acetyl groups in S-657 using the reductive-cleavage method. Carbohydrate Research, 2001. 331: p. 265-270.

Heteropolysaccharides can be incorporated into fluids used in the invention in amounts in one embodiment up to 1.5% by weight of total liquid phase, and in other embodiments in amounts ranging from about 0.01% to about 1.0% by weight of total liquid phase, and preferably from about 0.01% to about 0.6%, more preferably from about 0.01% to about 0.40%, by weight of total weight of liquid phase. The term liquid phase means all components of the fluid except any gas component.

In some embodiments, the heteropolysaccharide may be crosslinked with a suitable crosslinker. Adding crosslinkers to the fluid may further augment the viscosity of the fluid. Crosslinking consists of the attachment of two polymeric chains through the chemical association of such chains to a common element or chemical group. Suitable crosslinkers may comprise a chemical compound containing a polyvalent metal ion such as, but not necessarily limited to, chromium, iron, boron, aluminum, titanium, and zirconium.

Fluids useful in methods of the invention can also include proppant particles that are substantially insoluble in the fluids of the formation. Proppant particles carried by the treatment fluid remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it will typically be from about 16 to about 100 U.S. Standard Mesh in size. Naturally occurring materials may be underived and/or unprocessed naturally occurring materials, as well as materials based on naturally occurring materials that have been processed and/or derived. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particalization, processing, etc. Further information on nuts and composition thereof may be found in Encyclopedia of Chemical Technology, Edited by Raymond E. Kirk and Donald F. Othmer, Third Edition, John Wiley & Sons, Volume 16, pages 248-273 (entitled “Nuts”), Copyright 1981, which is incorporated herein by reference.

The concentration of proppant in the fluid can be any concentration known in the art, and will preferably be in the range of from about 0.05 to about 3 kilograms of proppant added per liter of liquid phase. Also, any of the proppant particles can further be coated with a resin to potentially improve the strength, clustering ability, and flow back properties of the proppant.

When incorporated, the gas component of the fluids useful in the invention may be produced from any suitable gas that forms an energized fluid when introduced into the aqueous medium. See, for example, U.S. Pat. No. 3,937,283 (Blauer et al.) hereinafter incorporated by reference. Preferably, the gas component is nitrogen, air, carbon dioxide, argon, and any mixtures thereof. More preferably the gas component comprises nitrogen or carbon dioxide, in any quality readily available. The gas component assists in the fracturing operation and the well clean-up process. The fluid may contain from about 10% to about 90% volume gas component based upon total fluid volume percent, preferably from about 30% to about 80% volume gas component based upon total fluid volume percent, and more preferably from about 40% to about 70% volume gas component based upon total fluid volume percent.

Aqueous fluids used in embodiments of the invention may also comprise an organoamino compound. Examples of suitable organoamino compounds include, but are not necessarily limited to, tetraethylenepentamine, triethylenetetramine, pentaethylenhexamine, triethanolamine, and the like, or any mixtures thereof. When organoamino compounds are used in fluids of the invention, they are incorporated at an amount from about 0.01 wt % to about 2.0 wt % based on total liquid phase weight. Preferably, when used, the organoamino compound is incorporated at an amount from about 0.05 wt % to about 1.0 wt % based on total liquid phase weight. A particularly useful organoamino compound is tetraethylenepentamine.

Energized fluids used in some method embodiments according to the invention can include a surfactant. Any surfactant for which its ability to aid the dispersion and/or stabilization of the gas component into the base fluid to form an energized fluid is readily apparent to those skilled in the art may be used. Viscoelastic surfactants, such as those described in U.S. Pat. No. 6,703,352 (Dahayanake et al.) and U.S. Pat. No. 6,482,866 (Dahayanake et al.), both incorporated herein by reference, are also suitable for use in fluids of the invention. In some embodiments of the invention, the surfactant is an ionic surfactant. Examples of suitable ionic surfactants include, but are not limited to, anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Examples of suitable ionic surfactants also include, but are not limited to, surfactants that are usually regarded as zwitterionic surfactants and in some cases as amphoteric surfactants such as alkyl betaines, alkyl amido betaines, alkyl amido sultaines, alkyl imidazolines, alkyl amine oxides and alkyl quaternary ammonium carboxylates. The amphoteric surfactant is a class of surfactant that has both a positively charged moiety and a negatively charged moiety over a certain pH range (e.g. typically slightly acidic), only a negatively charged moiety over a certain pH range (e.g. typically slightly alkaline) and only a positively charged moiety at a different pH range (e.g. typically moderately acidic), while a zwitterionic surfactant has a permanently positively charged moiety in the molecule regardless of pH and a negatively charged moiety at alkaline pH. In some embodiments of the invention, the surfactant is a cationic, zwitterionic or amphoteric surfactant containing and amine group or a quaternary ammonium group in its chemical structure (“amine functional surfactant”). A particularly useful surfactant is the amphoteric alkyl amine contained in the surfactant solution Aquat 944® (available from Baker Petrolite of 12645 W. Airport Blvd, Sugar Land, 77478 USA). Another particularly useful surfactant is the amphoteric alkyl amido sultaine contained in the surfactant solution Mirataine CBS (available from Rhodia Inc., 259 Prospect Plains Road CN 7500 Cranbury, N.J. 08512-7500). In other embodiments of the invention, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids of the invention. Preferably the fluids incorporate the surfactant or blend of surfactants in an amount of about 0.02 wt % to about 5 wt % of total liquid phase weight, and more preferably from about 0.05 wt % to about 2 wt % of total liquid phase weight.

Additional friction reducers may also be incorporated into fluids used in the invention. Any friction reducer may be used. Also, polymers such as polyacrylamide, polyisobutyl methacrylate, polymethyl methacrylate and polyisobutylene as well as water-soluble friction reducers such as guar gum, guar gum derivatives, xanthan gum, karaya gums, sodium carboxyethylcellulose, methylcellulose, natural gums, carboxyvinyl polymers with vinyl acrylamides, carboxymethylcellulose, and hydroxyethylcellulose, and polyethylene oxide may be used. Commercial drag reducing chemicals such as those sold by Conoco Inc. under the trademark “CDR” as described in U.S. Pat. No. 3,692,676 (Culter et al.) or drag reducers such as those sold by Chemlink designated under the trademarks “FLO 1003, 1004, 1005 & 1008” have also been found to be effective. These polymeric species added as friction reducers or viscosity index improvers may also act as excellent fluid loss additives reducing or even eliminating the need for conventional fluid loss additives.

Methods of the invention may also comprise a breaker used in the fluid. The purpose of this component is to “break” or diminish the viscosity of the fluid so that this fluid is more easily recovered from the formation during cleanup. With regard to breaking down viscosity, oxidizers, enzymes, acids, thermally activated radical initiators, redox initiators or pH modifiers may be used. Breakers reduce the polymer's molecular weight by the action of an acid, an oxidizer, an enzyme, or some combination of these on the polymer itself. In the case of borate-crosslinked gels, increasing the pH and therefore increasing the effective concentration of the active crosslinker, the borate anion, reversibly create the borate crosslinks. Lowering the pH can just as easily eliminate the borate/polymer bonds. At a high pH above 8, the borate ion exists and is available to crosslink and cause gelling. At lower pH, the borate is tied up by hydrogen and is not available for crosslinking, thus gelation caused by borate ion is reversible.

A fiber component may be included in the fluids to achieve a variety of properties including improving particle suspension, and particle transport capabilities, and gas phase stability. Fibers used may be hydrophilic or hydrophobic in nature, but hydrophilic fibers are preferred. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) Fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like. When used in the fluids of the invention, the fiber component may be include at concentrations from about 1 to about 15 grams per liter of the liquid phase of the fluid, preferably the concentration of fibers are from about 2 to about 12 grams per liter of liquid, and more preferably from about 2 to about 10 grams per liter of liquid

Fluids used in method embodiments of the invention may further contain other additives and chemicals that are known to be commonly used in oilfield applications by those skilled in the art. These include, but are not necessarily limited to, materials such as surfactants in addition to those mentioned hereinabove, breaker aids in addition to those mentioned hereinabove, oxygen scavengers, organic solvents, scale inhibitors, corrosion inhibitors, fluid-loss additives, bactericides, biocides, and the like. Also, they may include a co-surfactant to optimize viscosity or to minimize the formation of stable emulsions that contain components of crude oil or at least one additional polysaccharide polymer comprising 1,2-cis hydroxyls or chemically modified polysaccharide polymer comprising 1,2-cis hydroxyls, such as cellulose, derivatized cellulose, guar gum, derivatized guar gum, xanthan gum, scleroglucan or synthetic polymers such as polyacrylamides and polyacrylamide copolymers. The fluids used in the invention may also contain a ligand such as a polyol comprising 1,2-cis hydroxyls (glycerol, sorbitol, gluconic acid salts, mannitol, and the like, by non limiting example), oxygen scavengers such as sodium thiosulfate or even oxidizers such as ammonium persulfate, peroxides, and sodium bromate.

When organic solvents are incorporated into fluids, any suitable solvent may be used. Also, a plurality of solvents may be incorporated. Examples of suitable solvents include hydrocarbons, such as mineral oil, oxygenated solvents, such as glycol ethers, alcohols, ethers, ketones, esters, biodiesel, oxygenated/hydrocarbon solvent mixtures, and the like. Organic solvents are typically incorporated in an amount from about 0.05% to about 70% by weight based on total liquid phase weight, preferably from about 0.1% to about 35% by weight based on total liquid phase weight.

The methods of the invention use fluids incorporating a heteropolysaccharide which readily hydrates. In some embodiments, the heteropolysaccharide polymer based fluid reaches a level of about 85 percent hydration or higher within one minute from mixing with the aqueous medium in an appropriate mixer, such as a WARING blender or full scale vortex mixer, for example. Percent hydration as used herein is based upon viscosity measurements, such as those made with a Fann35 viscometer which is commonly known to those with skill in the art. To determine percent hydration, a first viscosity measurement is made on a fluid at about 1 minute after mixing the polymer and aqueous medium, and a second measurement is made at 30 minutes after mixing. Fore purposes herein, the percent ratio of the 1 minute measurement to the 30 minute measurement is deemed the percent hydration.

Treatment methods of invention are useful in oilfield operations, including such operations as fracturing subterranean formations, modifying the permeability of subterranean formations, fracture or wellbore cleanup, acid fracturing, matrix acidizing, gravel packing or sand control, and the like. Another application includes the placement of a chemical plug to isolate zones or to assist an isolating operation. These methods can be used at any suitable formation temperature.

Techniques for hydraulically fracturing a subterranean formation will be known to persons of ordinary skill in the art, and will involve pumping the fracturing fluid into the borehole and out into the surrounding formation. The fluid pressure is above the minimum in situ rock stress, thus creating or extending fractures in the formation. See Stimulation Engineering Handbook, John W. Ely, Pennwell Publishing Co., Tulsa, Okla. (1994), U.S. Pat. No. 5,551,516 (Normal et al.), “Oilfield Applications”, Encyclopedia of Polymer Science and Engineering, vol. 10, pp. 328-366 (John Wiley & Sons, Inc. New York, N.Y., 1987) and references cited therein, the disclosures of which are incorporated herein by reference thereto.

In most cases, a hydraulic fracturing consists of pumping a proppant-free viscous fluid, or pad, usually water with some fluid additives to generate high viscosity, into a well faster than the fluid can escape into the formation so that the pressure rises and the rock breaks, creating artificial fractures and/or enlarging existing fractures. Then, proppant particles are added to the fluid to form a slurry that is pumped into the fracture to prevent it from closing when the pumping pressure is released. The proppant suspension and transport ability of the treatment base fluid traditionally depends on the type of viscosifying agent added.

In one embodiment, this invention can be used as a drag reducing agent in water based stimulation fluids with superior proppant carrying capacity. When transporting proppant in a pipe at a high pumping rate, the total pressure drop in the pipe in the presence of the fluid is lower than in the presence of water or brine. This embodiment would add a heteropolysaccharide polymer to water in less than 1.5% by weight, preferably less than 1.0% by weight, more preferably less than 0.5% by weight, based on the total liquid phase weight and achieve a percent drag reduction of at least 50%, more preferably 60%, at typical linear fluid velocities, calculated as the ratio of the volumetric flow rate to the cross-sectional area, of at least 4 m/s (13.1 ft/s) corresponding to about 5.2 m³/min (32.7 bbl/min) in 166 mm internal diameter casing (nominal 7-in. casing, internal diameter 6.535 in.) and 0.37 m³/min (2.3 bbl/min) in 144 mm internal diameter coiled tubing (nominal 2-in tubing, internal diameter 1.732 in.). The elastic modulus (G′) of the embodiment is preferably less than 29.0 Pa, more preferably less than 15.0 Pa, and especially less than 10.0 Pa, and the viscosity at a temperature of 25° C. and a shear rate of 100 s⁻¹ is preferably at least 5, at least 7, and more preferably at least 10 mPa-s, and/or the viscosity at a temperature of 25° C. and a shear rate of 0.1 s⁻¹ is preferably at least 100, at least 150, at least 200, at least 300, and more preferably at least 500 mPa-s in various embodiments. This embodiment of the invention can be used in the pad stage of a hydraulic fracturing treatment to initiate and propagate a fracture in the formation. This pad can be followed by a series of proppant laden stages where the main fluid comprise the heteropolysaccharide drag reducer of the present invention, a conventional polymeric drag reducer, a linear polymer gel, a crosslinked polymer gel, or a viscoelastic (“VES”) gel, or a VES-based friction reducer. In some fracturing treatments, fluids of the invention may be used in both the pad treatment and the proppant stage.

In another embodiment, this invention can be used in the proppant laden stages of a frac job following a pad of a polymeric drag reducer, a linear polymer gel, a crosslinked polymer gel, or a VES gel.

In another embodiment, this invention can be used in conjunction with fibers and proppants to further provide physical support for proppants.

In another embodiment, this invention can be used with various proppants with different densities (for example, from about 0.5 to about 4.0 kg/l), and coatings to place a conductive channel into a fractured rock.

In another embodiment, this invention can be used in conjunction with fibers to act as a diverting agent to divert treatment fluids from high permeability zones in a formation to lower ones.

In another embodiment, this invention can be turned into an energized fluid by adding a gas phase to the fluid and creating an emulsion with nitrogen, methane or carbon dioxide.

In another embodiment, this invention can be used in conjunction with fluid loss additives.

In another embodiment, this invention can be used as a conformance control fluid, as an enhanced oil recovery fluid, as a drag reducing agent in oil pipes.

The components of the liquid phase are preferably mixed on the surface. Alternatively, a the fluid may be prepared on the surface and pumped down tubing while the gas component could be pumped down the annular to mix down hole, or vice versa.

In some embodiments of the invention, the compositions and methods of the invention may involve injecting heteropolysaccharide polymer fluids into wellbores without residence time in hydration tanks prior to injection. Employing such methods may reduce equipment on the surface of a wellsite location that is needed to complete a fracturing job, which is particularly beneficial when operable space is limited. In addition, equipment and maintenance associated with hydration tanks and associated equipment can be essentially eliminated.

When introduced into the wellbore without residence time in hydration tanks, the heteropolysaccharide may be mixed with such other components as aqueous medium, gas component, a surfactant, an electrolyte, or other materials known to those with skill in the art useful in oilfield fluids, either at the surface, or below the surface. For example, the heteropolysaccharide may be mixed at the surface with the aqueous medium, surfactant, electrolyte, and any other additives, and then, if desired, combined downhole with a gas component to form the foam or energized fluid.

Yet another embodiment of the invention includes the use of fluids based on the invention for cleanup. The term “cleanup” or “fracture cleanup” refers to the process of removing the fracture fluid (without the proppant) from the fracture and wellbore after the fracturing process has been completed. Techniques for promoting fracture cleanup traditionally involve reducing the viscosity of the fracture fluid as much as practical so that it will more readily flow back toward the wellbore. While breakers are typically used in cleanup as energized fluids, the fluids of the invention are inherently effective for use in cleanup operations, with or without a breaker.

In another embodiment, the present invention relates to use of fluids based on the invention for gravel packing a wellbore. As a gravel packing fluid, it preferably comprises gravel or sand and other optional additives such as filter cake clean up reagents such as chelating agents referred to above or acids (e.g. hydrochloric, hydrofluoric, formic, acetic, citric acid) corrosion inhibitors, scale inhibitors, biocides, leak-off control agents, among others. For this application, suitable gravel or sand is typically having a mesh size between 8 and 70 U.S. Standard Sieve Series mesh. In this embodiment the fluid is preferable used as a high rate gravel pack or water pack.

The following examples are presented to illustrate the preparation and properties of aqueous fluids comprising heteropolysaccharides and a surfactant, and should not be construed to limit the scope of the invention, unless otherwise expressly indicated in the appended claims. All percentages, concentrations, ratios, parts, etc. are by weight unless otherwise noted or apparent from the context of their use.

### EXAMPLES

### Example 1

The friction or drag reduction of various fluids was measured in a laboratory friction loop having a high flow rate triplex pump and a pipe grid where the fluid is pumped through a series of stainless steel tubes of different external diameters, namely, 12.7 mm (½ inch) and 9.53 mm (⅜ inch). A mass flowmeter (MicroMotion Elite) was used to measure the flow rate, fluid density and fluid temperature in real time. Each tube size had dedicated differential pressure transducers (Rosemount 3051 SMART) used to measure the pressure drop across a 1.83 m (6 feet) long section of the tube. In addition, each tube was at least 4.27 m (14 feet) in length to allow the flow to achieve steady state before the pressure measurement. The fluids were recirculated from the tube to the pump feed tank.

There are various alternatives accepted in the literature that can be used to show the effect of friction reducers in non-Newtonian fluids. The most commonly used method involves plotting the % drag reduction (% DR) against the mass flow rate. The drag reduction can be estimated from pressure differential measurements as those performed with the equipment and procedure described above. Pressure differential for the fluid of the invention ΔP_{f} is compared to that of the fluid without the materials that are subject of the invention ΔP_{w} and reported as per the following formula:

$$\% DR = \frac{Δ {P}_{w} - Δ {P}_{f}}{Δ {P}_{w}} \times 100$$

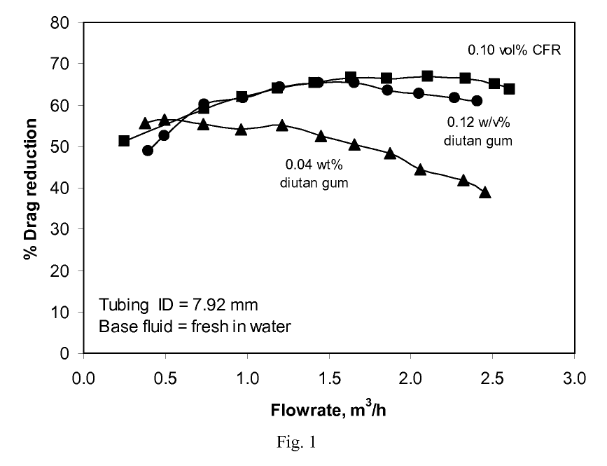

For this example, the pressure drop over the 1.83 m straight section of the 9.53 mm tube was measured when pumping various fluids at increasing mass flow rates compared with that of water under the same conditions. Solutions of a dry diutan heteropolysaccharide powder (available from CP Kelco of 123 North Wacker Dr, Suite 2000 Chicago, Ill. 60606 USA) at concentrations of 0.04 and 0.12 grams per liter (3.3 and 10 lb/1000 gal) were pumped through the friction loop. For comparison, a concentrated proprietary conventional drag reducing formulation (“CFR”) containing a 28 wt % of active vinyl polymer was mixed in water at a concentration of 0.1 vol % and pumped through the friction loop. The CFR is used for benchmarking of this invention. As shown in FIG. 1, the solutions comprising 0.04 wt % and 0.12 wt % heteropolysaccharide exhibited excellent and moderate drag reduction, respectively. Furthermore, these solutions exhibited similar or better drag reduction than the commercial CFR.

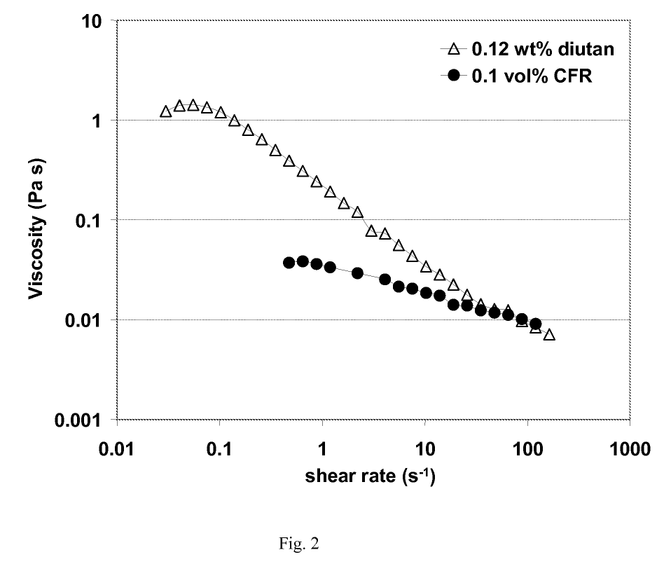

FIG. 2 compares the 25° C. viscosity as a function of shear rate, measured in a Bohlin CVOR 200 rheometer using a titanium double gap 24/27 geometry, of the aqueous 0.12 wt % diutan heteropolysaccharide solution and the CFR at a concentration of 0.10 vol %. As can be observed for fluids with similar drag reduction capabilities, the viscosity of the diutan heteropolysaccharide fluid at low shear rates, e.g. 0.05 s⁻¹, is approximately 300 times higher than that of the CFR. Stokes law can be used to estimate the terminal velocity, also known as the settling velocity, of particles falling in a viscous fluid by their own weight, when the frictional force combined with the buoyant force exactly balance the gravitational force. The resulting settling velocity is given by:

$${V}_{s} = \frac{2}{9} \frac{{r}^{2} g ( {ρ}_{p} - {ρ}_{f} )}{η}$$

where Vₛ is the particles' settling velocity (cm/sec) (vertically downwards if ρₚ>ρ_{f}, upwards if ρₚ<ρ_{f}), r is the Stokes radius of the particle (cm), g is the standard gravity (cm/sec²), ρₚ is the density of the particles (g/cm³), ρ_{f} is the density of the fluid (g/cm³), and η is the fluid viscosity (mPa s). It is seen that the ability of a viscous fluid to suspend low concentrations of solids, such as sand or gravel, depends on the viscosity of the fluid. Therefore, the diutan heteropolysaccharide can suspend sand much more effectively than the CFR fluid, an advantageous result for high rate water fracturing treatments and high rate water pack treatments.

### Example 2

Solutions with varying concentrations of diutan heteropolysaccharide in 10 wt % KCl aqueous solutions and in 38.5 wt % NaBr aqueous solutions were pumped through coiled tubing in a series of yard tests to assess the benefits of this invention at a scale comparable to that of a well treatment operation. The experimental setup consisted of a 5.6-m³ mixing tank connected to a hydraulic pump with flow capacity of up to 640 L/min. The discharge of the pump was connected in such a way that the flow could be directed to one of two coiled tubing reels, one with external diameter of 3.81 cm (1.5 in.), internal diameter of 3.12 cm and length of 3810 m, and another with external diameter of 4.45 cm (1.75 in.), internal diameter of 3.96 cm and length 1370 m. The discharges of the coiled tubing reels were connected in a manner that the flow was returned to the mixing tank. Pressure transducers were placed in both ends of the coiled tubing reels to measure frictional pressure losses.

In a typical test, 4.0 m³ of the fluid of interest were mixed and circulated through the configuration described above with increasing flow rate until reaching either the maximum flow rate of the pump or the maximum operating pressure of the system. Recirculation was allowed for each flow rate until a steady pressure differential was attained, and the corresponding measurement was recorded. Experiments were performed first with the flow directed to the coiled tubing with external diameter of 3.81 cm, and second with the flow directed to the coiled tubing with 4.45 cm. At the end of a test for given coiled tubing, the fluid was displaced from the reel and back to the mixing tank by pumping nitrogen through the system.

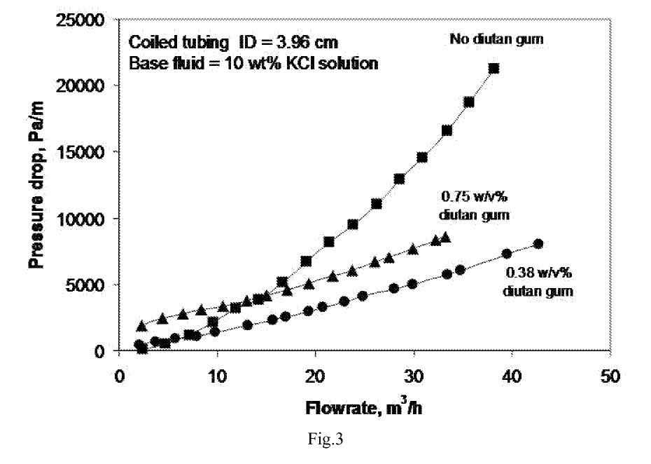

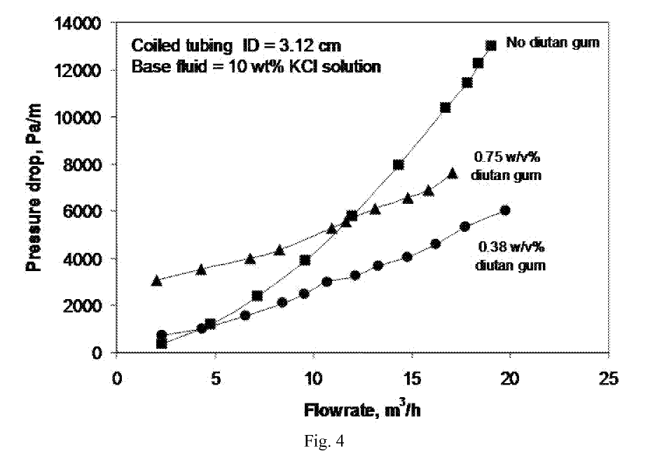

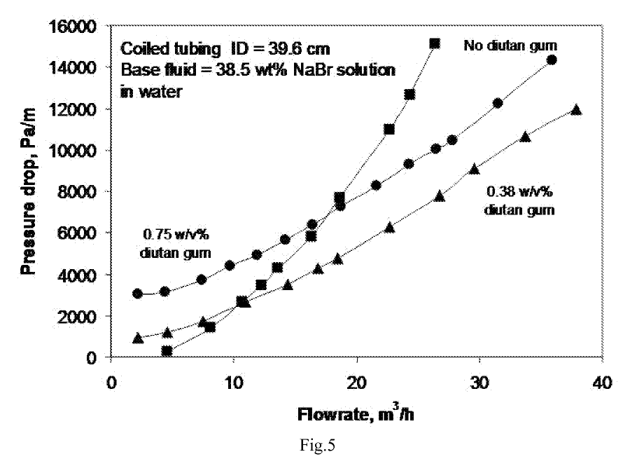

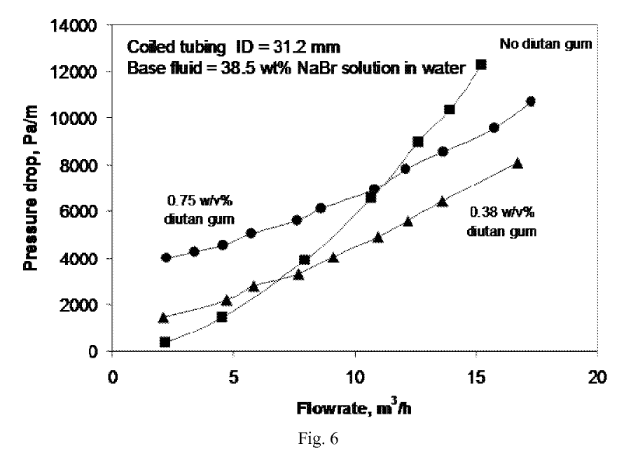

As shown in FIGS. 3 through 6, frictional pressure losses can be substantially inhibited by the addition of heteropolysaccharide. These figures also show that the benefit of drag reduction is particularly significant at high flow rates

### Example 3

In fracturing treatments, the fluids generally permeate across the fracture face into the formation through a process commonly known as fluid loss, as a function of the pressure difference between the fluid and the formation pore pressure. For polymer-containing fluids, this can result in a concentration of the polymer in the fluid that can vary between 2 and 20 times the original concentration. The polymer molecules contained in the fluids used in high rate water fracturing treatments can preferentially concentrate on the fracture face, forming what is commonly known as filter cake. This filter cake can restrict the flow of reservoir fluids to the newly formed fracture, what is commonly called fracture damage, which is often sought to be minimized by the use of radical, oxidative, acid, enzyme or redox breakers, pumped with the fracturing fluids, in solution or encapsulated, to reduce the polymer molecular weight.

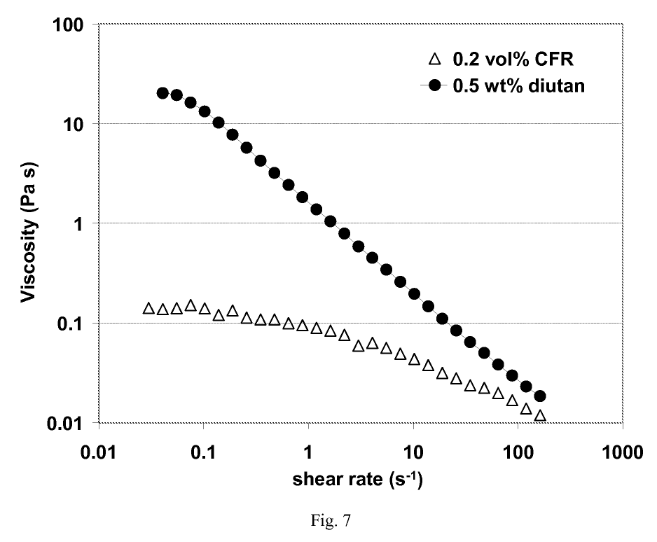

To verify the response of the diutan friction reducer fluids of the invention to common fracturing fluid breakers, the following experiments were performed. A 0.5 wt % diutan heterosaccharide solution, four times more concentrated than in Example 1, was treated at 79.5° C. (175° F.) for a period of 4 hours with 0.6 wt % sodium persulfate breaker, a sufficiently high concentration to simulate the effective concentration of breaker in a typical filter cake after the fluid is concentrated through the fluid loss process, or localized by release of an encapsulated breaker. FIG. 7 shows the 25° C. viscosity of the diutan fluid using the equipment and procedure of Example 1 prior to the addition of the breaker. Upon visual inspection of the fluid sample after degradation by the breaker, a low viscosity, water-like broken fluid with minor precipitation was observed.

A 0.2 vol % CFR solution, only two times more concentrated than in Example 1, was treated at 79.5° C. (175° F.) for a period of 4 hours with 0.6 wt % sodium persulfate breaker. FIG. 7 shows the 25° C. viscosity of such fluid measured with the equipment and following the procedure described in Example 1 prior to the addition of the breaker. Upon visual inspection of the CFR fluid sample after degradation by the persulfate breaker, a medium-low viscosity, partially broken fluid with precipitate formation was observed.

A 0.5 wt % diutan heteropolysaccharide solution was also treated at 45° C. (115° F.) for a period of 4 hours with 0.3 wt % sodium persulfate breaker and 0.3 wt % ferrous sulfate heptahydrate breaker activator. Upon visual inspection of the diutan fluid sample after degradation by the persulfate/activator, a low viscosity, water-like broken fluid with minor precipitation was observed.

The 0.2 vol % CFR solution was similarly treated at 45° C. (115° F.) for a period of 4 hours with 0.3 wt % sodium persulfate breaker and 0.3 wt % ferrous sulfate heptahydrate breaker activator. Upon visual inspection of the CFR fluid sample after degradation by the persulfate/activator, a low viscosity, water-like broken fluid with extensive precipitation was observed.

It was thus found that the diutan friction reducer fluid can be more effectively broken than the CFR with sodium persulfate, and that it can be broken similarly to the CFR fluid with sodium persulfate in the presence of iron (II), with substantially less solid precipitation.

### Example 4

Mixtures of diutan heteropolysaccharide and CFR at different concentrations were prepared to verify the effect of such mixtures in the viscosity of the fluid, and to ascertain whether such fluid mixtures could be compatible.

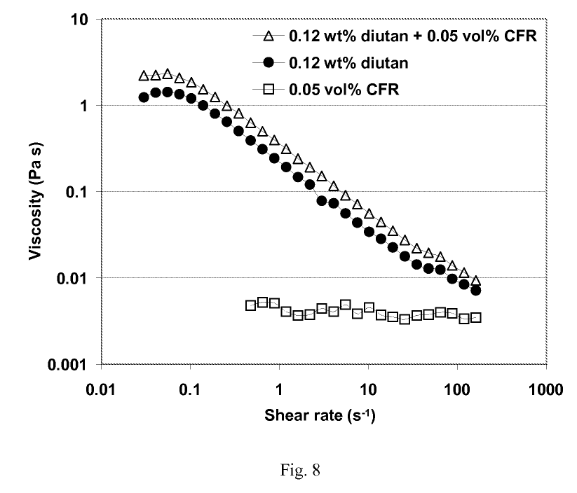

FIG. 8 shows the viscosity of mixtures of diutan and CFR at 0.12 wt % diutan and 0.05 vol % CFR as compared to a fluid containing only 0.12 wt % diutan, and a fluid containing only 0.05 vol % CFR. Such mixed fluids can provide excellent friction reduction and improved sand suspension capabilities over the fluids containing diutan heteropolysaccharide or CFR only.

### Example 5

A mixture of 0.12 wt % of diutan heteropolysaccharide and a viscoelastic surfactant, comprising 0.75 vol % of a zwitterionic surfactant and 0.75 vol % of a viscosity enhancer, was prepared. Neither haziness nor precipitation was observed, thus indicating that diutan gum and VES can be blended without exhibiting incompatibilities. This mixture provides similar drag reduction to the diutan-only fluid, and enhanced sand suspension.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of treating a well, comprising:
pumping at least one stage of an aqueous fluid system into the well at a rate to incur friction pressure losses;
wherein the fluid system comprises a heteropolysaccharide friction reducing agent in an amount up to 1.5 percent by weight of a liquid phase to provide a drag reduction of at least 50%.

2. (canceled)

3. (canceled)

4. The method according to claim 1 comprising slick-water fracturing of a subterranean formation.

5. The method according to claim 1 comprising high rate water packing of the well.

6. The method according to claim 1 comprising clean out of the well.

7. The method according to claim 1 wherein the pumping rate generates a linear fluid velocity of at least 4 m/s calculated as a ratio of volumetric flow rate to cross-sectional flow area.

8. The method according to claim 1 wherein the heteropolysaccharide comprises a tetrasaccharide repeating unit in the polymer backbone represented by the chemical formula: 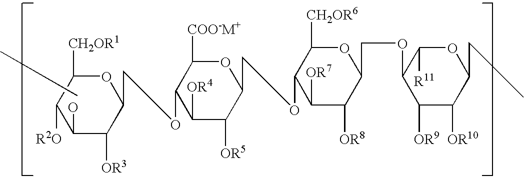
wherein three different saccharide units are present in the repeating unit including D-glucose, D-glucuronic acid, and either L-rhamnose or L-mannose; M⁺ is an ionic species; R¹, R², R³, R⁴, R⁵, R⁶, R⁷, R⁸, R⁹, and R¹⁰ are selected from the group consisting of hydrogen, methyl, acetyl, glyceryl or a saccharide group containing one to three saccharide units; R¹¹ is a methyl or methylol group; a weight average molecular weight (Mw) for the heteropolysaccharide is from about 10⁵ to about 10⁷.

9. The method according to claim 1 wherein the heteropolysaccharide is selected from the group consisting of gellan gum and derivatives thereof, diutan gum and derivatives thereof, rhamsan gum and derivatives thereof, polysaccharide S-88 and derivatives thereof, polysaccharide S-198 and derivatives thereof, polysaccharide NW11 and derivatives thereof, and mixtures thereof.

10. The method according to claim 1 wherein the heteropolysaccharide comprises a hexasaccharide repeating unit in the polymer backbone represented by the chemical 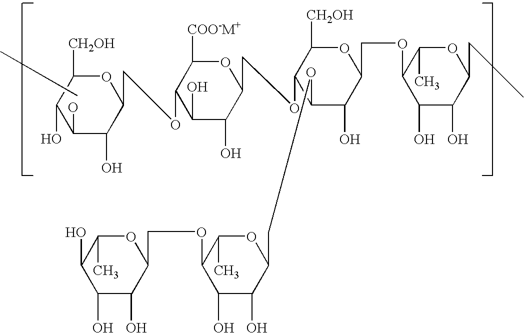
formula:
wherein M⁺ is an ionic species and a weight average molecular weight for the heteropolysaccharide is from about 10⁵ to about 10^{7.}

11. (canceled)

12. The method according to claim 1 wherein the drag reduction is at least 60%.

13.-19. (canceled)

20. The method according to claim 1 comprising an initial proppant-lean pad stage to initiate and propagate a fracture in a subterranean formation adjacent the well followed by a series of proppant-laden stages, wherein the proppant-laden stages comprise the fluid system with the heteropolysaccharide friction reducing agent, and wherein the initial pad stage comprises an aqueous fluid system comprising a friction reducing agent that can be the same or different than the heteropolysaccharide.

21. (canceled)

22. (canceled)

23. The method according to claim 1 comprising an initial proppant-lean pad stage to initiate and propagate a fracture in a subterranean formation adjacent the well followed by a series of proppant-laden stages, wherein the proppant-laden stages comprise the fluid system with the heteropolysaccharide friction reducing agent, and wherein the initial pad stage comprises an aqueous fluid system comprising a gelling agent.

24.-26. (canceled)

27. The method according to claim 1 wherein the aqueous fluid system is energized with a gas phase.

28.-30. (canceled)

31. The method according to claim 1 wherein the aqueous fluid system further comprises fibers and the at least one stage diverts treatment fluid from a formation zone of relatively high permeability to a formation zone of relatively low permeability.

32. (canceled)

33. The method according to claim 1 wherein the at least one stage comprises an enhanced oil recovery flood stage.

34. (canceled)

35. The method according to claim 1 wherein the heteropolysaccharide is crosslinked.

36. The method of claim 1 wherein the aqueous fluid system comprises a breaker for the heteropolysaccharide.

37.-41. (canceled)

42. A method of treating a well and producing fluid from a subterranean formation adjacent to the well, comprising:
pumping at least one stage of an aqueous fluid system into the well at a rate to incur friction pressure losses, wherein the fluid system comprises a heteropolysaccharide friction reducing agent in an amount up to 1.5 percent by weight of a liquid phase to provide a drag reduction of at least 50%; and
producing fluid from the subterranean formation.

43. (canceled)

44. (canceled)

45. The method according to claim 42 comprising slick-water fracturing of a subterranean formation.

46.-48. (canceled)

49. The method according to claim 42 wherein the heteropolysaccharide comprises a tetrasaccharide repeating unit in the polymer backbone represented by the chemical formula: 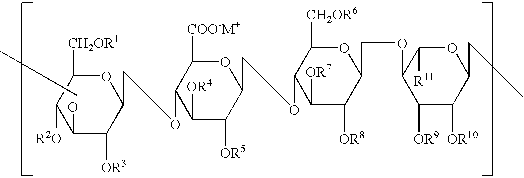
wherein three different saccharide units are present in the repeating unit including D-glucose, D-glucuronic acid, and either L-rhamnose or L-mannose; M⁺ is an ionic species; R¹, R², R³, R⁴, R⁵, R⁶, R⁷, R⁸, R⁹, and R¹⁰ are selected from the group consisting of hydrogen, methyl, acetyl, glyceryl or a saccharide group containing one to three saccharide units; R¹¹ is a methyl or methylol group; a weight average molecular weight (Mw) for the heteropolysaccharide is from about 10⁵ to about 10⁷.

50. The method according to claim 42 wherein the heteropolysaccharide is selected from the group consisting of gellan gum and derivatives thereof, diutan gum and derivatives thereof, rhamsan gum and derivatives thereof, polysaccharide S-88 and derivatives thereof, polysaccharide S-198 and derivatives thereof, polysaccharide NW11 and derivatives thereof, and mixtures thereof.

51. The method according to claim 42 wherein the heteropolysaccharide comprises a hexasaccharide repeating unit in the polymer backbone represented by the chemical formula: 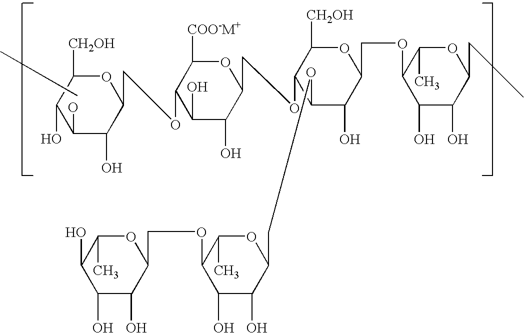
wherein M⁺ is an ionic species and a weight average molecular weight for the heteropolysaccharide is from about 10⁵ to about 10⁷.

52.-60. (canceled)

61. The method according to claim 42 comprising an initial proppant-lean pad stage to initiate and propagate a fracture in a subterranean formation adjacent the well followed by a series of proppant-laden stages, wherein the proppant-laden stages comprise the fluid system with the heteropolysaccharide friction reducing agent, and wherein the initial pad stage comprises an aqueous fluid system comprising a friction reducing agent that can be the same or different than the heteropolysaccharide.

62. (canceled)

63. (canceled)

64. The method according to claim 42 comprising an initial proppant-lean pad stage to initiate and propagate a fracture in a subterranean formation adjacent the well followed by a series of proppant-laden stages, wherein the proppant-laden stages comprise the fluid system with the heteropolysaccharide friction reducing agent, and wherein the initial pad stage comprises an aqueous fluid system comprising a gelling agent.

65.-75. (canceled)

76. The method according to claim 42 wherein the heteropolysaccharide is crosslinked.

77.-82. (canceled)
